(19) United States
(12) Patent Application Publication
(10) Pub. No.: US 2023/0389518 A1
(43) Pub. Date: Dec. 7, 2023

(54) PET SHOWER

(71) Applicant: Leon Whitsett, Detroit, MI (US)

(72) Inventor: Leon Whitsett, Detroit, MI (US)

(21) Appl. No.: 18/206,671

(22) Filed: Jun. 7, 2023

Related U.S. Application Data
(63) Continuation-in-part of application No. 17/147,046, filed on Jan. 12, 2021, now abandoned.
Application No. 17/147,046 is a continuation-in-part of application No. 14/018,416, filed on Sep. 5, 2013, now abandoned.

(51) Int. Cl. A01K 13/00

(52) U.S. Cl. CPC A01K 13/001

(57) ABSTRACT

The present invention provides a pet shower having a washing compartment defined by interconnectable upper and lower compartments which cooperate to define an open interior. Each compartment has a portal which cooperates to define an ingress and egress for an animal. A ramp enables an animal to enter the interior of the washing apparatus. A removable slotted door closes off the portal when the shower is in use.

### CROSS-REFERENCE TO RELATED APPLICATION

This application is a continuation in part of Co-pending U.S. patent application Ser. No. 17/147,046, filed on Jan. 12, 2021, which, in turn, is a continuation in part of U.S. patent application Ser. No. 14/018,416, filed on Sep. 5, 2013, for “A Pet Washing Apparatus for Dogs and Like Animals,” the disclosures of which are hereby incorporated by reference, including the drawings.

### BACKGROUND OF THE INVENTION

### 1. Field of the Invention

The present invention concerns a washing apparatus. More particularly, the present invention concerns a pet washing apparatus for dogs and other animals.

### 2. Prior Art

In the above-referenced co-pending application, there is disclosed a “shower” for facilitating the washing of dogs and similar type pets. The device shown therein, while being extremely efficacious, has certain drawbacks, including, inter alia, difficulty in manufacture because of the dual wall system disclosed therein, through which the necessary water delivery conduits are disposed. Furthermore, the “portability” of this prior device was, in essence, non-existent.

Thus, the present invention seeks to improve upon such prior art device by having improved air circulation, water delivery and discharge, as well as ease of manufacture and portability.

For a more complete understanding of the present invention, reference is made to the following detailed description and accompanying drawing. In the drawing, like reference characters refer to like parts throughout the several views in which:

### DESCRIPTION OF THE DRAWING

FIG. 1 is a perspective view showing the shower hereof;

FIG. 2 is a perspective view hereof with the door removed, and which includes a ramp associated therewith;

FIG. 3 is a perspective view showing the bottom wall of the lower compartment with the legs removed;

FIG. 4 is a perspective view of a height enhancing block contemplated for use herein; and

FIG. 5 is a perspective view of a ground engaging pad used herein.

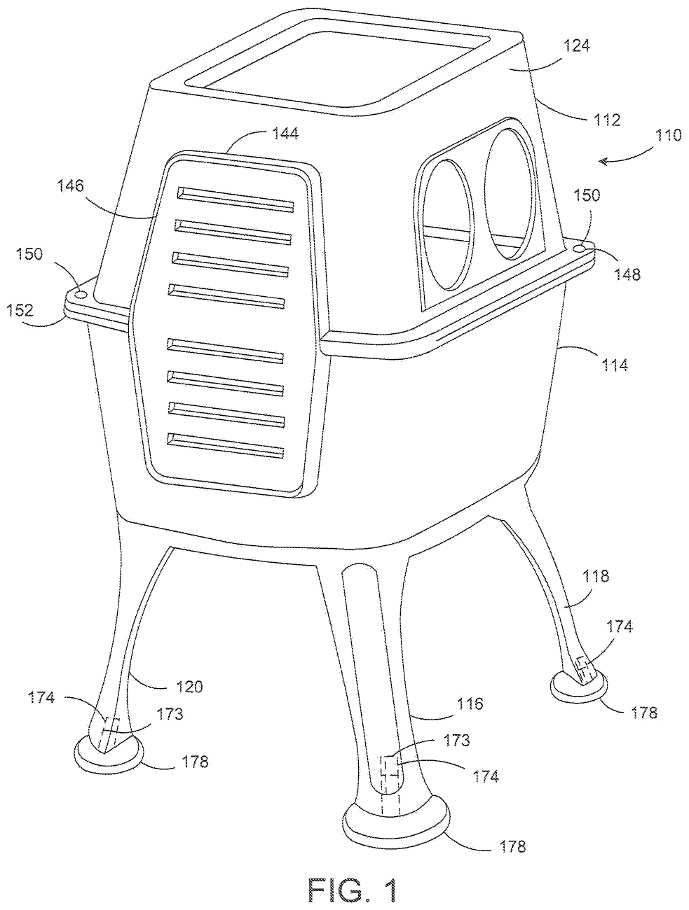

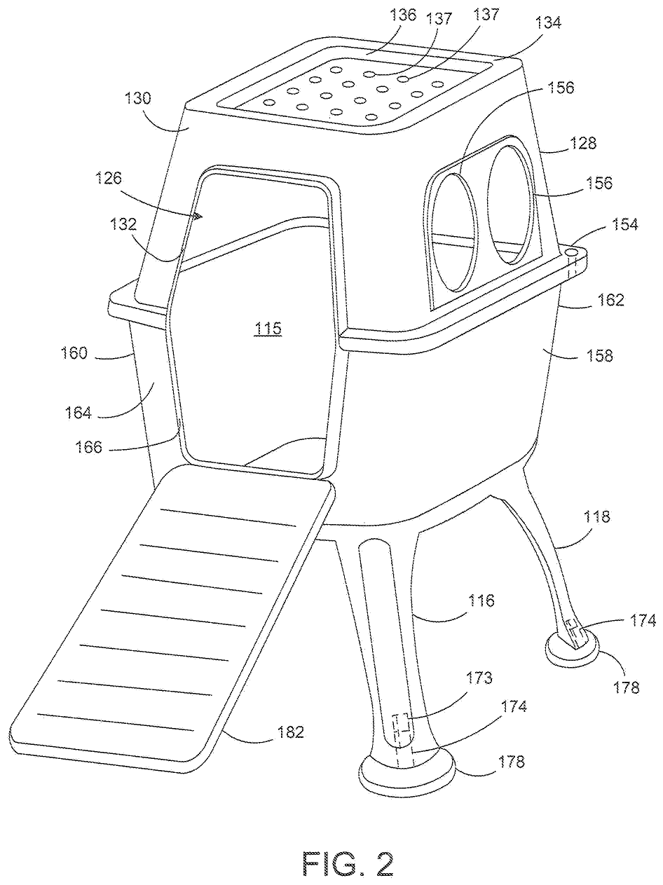

### DESCRIPTION OF THE INVENTION

Referring to the drawing, there is depicted therein a further embodiment of the shower hereof and in accordance with the present invention. According to this embodiment, the present shower denoted at 110, generally, comprises a separable component pet shower having (a) a transparent upper portion or compartment 112 and (b) a lower portion or compartment 114. The compartments are detachably secured together and cooperate to define an open interior 115 when secured together.

The device further including four legs or stanchions (only three of which are shown) at 116, 118 and 120, which enable the shower to be safely positioned either on the ground or on a suitable surface.

With more particularity, the upper compartment 112, generally, has a substantially rectangular or frustoconical configuration including integrally formed first and second side walls 124, 126, a rear wall 128, an opposed portal or entry wall 130, having an access portal or opening 132 and a top wall 134, having a central recess 136. As shown, the portal 132 enables access into the interior 115 of the shower, as described below.

An apertured or slotted door 142 seals off access into the interior. The door 142 may be detachably hingedly connected to the upper section, over the portal, at its uppermost edge as at 144, or at its side 146.

The door 142 is complimentarily configured to the dimensions of the portal entry wall 130 and is defined by the geometry of the portals or openings in both the upper and lower compartments 112, 114, as shown.

The upper compartment 112 has a peripheral lip or flange 148 provided at the bottom thereof. The flange 148 is provided with suitable openings 150, preferably, at the intersections of the walls 124, 126, 128 and 130.

As discussed hereinbelow, these openings register with like openings provided in the lower portion 114 which overlies a like flange or lip 152 formed on the lower compartment, through which fasteners 154 (only one of which is shown) may be inserted to detachably secure the upper and lower portions or sections together.

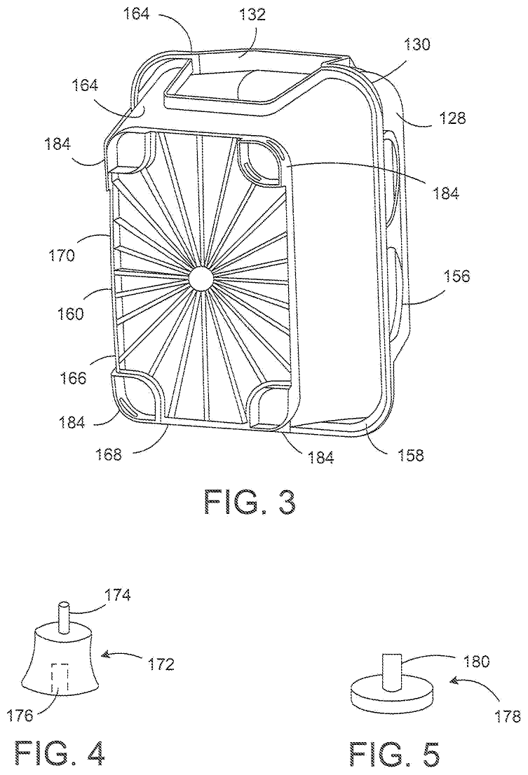

As shown in FIG. 3, a central recess 136, having a plurality of apertures 137 are provided in the recess 136 and which extend into the interior 115. The apertures 135 enable air to be circulated into the interior 115.

As with other embodiments, suitable means 156 are provided to enable the hands of the user to access the interior 115 of the device 110 to wash the animal. The access means may be provided on both side walls or just one side wall, as shown.

According to this embodiment, the lower section 114 includes opposed side walls 158, 160, a rear wall 162 and a portal opening wall 164 which, as noted, has a portal or opening 166 which is complimentarily configured to the portal 132 in the upper section to provide continuous geometric opening for access for ingress and egress for an animal into the interior 115.

As shown in FIG. 3, the lower compartment further includes an inclined bottom surface 167 which is inclined or tapered toward the center thereof. A drainage opening 168 is provided therein which can be sealingly closed, via a plug 170, or the like, during use and which can be opened to drain any liquid from the interior. Leg receptors 184 are provided at each corner of the bottom surface 167 to enable the legs to be detachably connected thereto. The legs are snuggly nested in the receptors. Other means, such as fasteners or the like may be used to removeably secure the legs into position.

As shown, the legs or stanchions are disposed at each corner of the lower section to impart stability thereto.

Alternatively, and as shown in FIG. 4, a block 172 may be removably affixed to each leg. Each block is configured coincident with an associated leg to provide a continuum to the configuration of each associated leg. A central bore 173 is provided at the base of each leg and extends upwardly. A central peg 174 is affixed to the top of the block and is removably seatable in the bore 173 of an associated leg 116, 118, 120, etc.

A bore 176 is provided in the base of each block such that it can removably seat a pad 178, as described below.

The pad 178, having an upstanding peg 180 may be fitted to an associated leg at its terminus for providing a greater surface area when placed upon the ground or other horizontal surface. In this embodiment, as noted, each leg has a central bore 173 which removably receives an associated peg 180. Alternatively, each pad 178 may be removably attached to an associated block by inserting its peg into the bore 176 of each block 172 which, in turn, is fitted to a leg.

In some embodiments hereof, each leg may comprise at least a pair of sections which are telescopically interconnected to enable lengthening or shortening of the legs, as desired.

In some embodiments, a stepped ramp 182 may be used to enable the animal to climb upon to enter through the portal into the interior. The ramp preferably detachably mounts to the lower compartment portal wall at the lower edge thereof, as shown.

It should be further pointed out that due to the dimensioning of the upper and lower sections, the upper section, when detached from the lower section, may be inverted and nested within the lower section and as such to be used for waste matter or other collection.

Although not shown in the drawing, but similar to the first embodiment, the upper portion is provided with a shower head connected to a water source via a hose or the like for delivering water for shampooing the animal which is, preferably, a domestic animal, e.g., a dog or cat. Alternatively, a water hose with a nozzle may be used to wash the animal.

The present device can be manufactured from any suitable material, such as a synthetic resinous material, for example, a light-weight polypropylene or other plastic.

From the foregoing, it is apparent that there has been described an animal washing device that is easy to use, inexpensive to manufacture and readily transportable.

Having, thus, described the invention, what is claimed is:

### LISTING OF REFERENCE NUMERALS

110 present pet shower device
112 upper compartment
114 lower compartment
115 interior
116,118,120 legs or stanchions
124 upper compartment side wall
126 opposed upper compartment side wall
128 rear wall
130 entry wall
132 access portal, opening
134 top wall
135 apertures
136 central recess
137 apertures
142 door
144,146 lower portion side walls
148 flange
150 openings
152 flange or lip
154 fasteners
156 means
158,160 opposed side wall
162 rear wall
164 portal opening wall
166 portal, opening
167 inclined bottom surface
168 drainage opening
170 plug
172 block
173 central bore
174 central peg
176 bore
178 pad
180 upstanding peg
182 stepped ramp
184 receptors

1. An animal shower comprising:
(a) a transparent upper shower compartment having a front wall, having a cutout portion, a rear wall, a top wall, a bottom wall and a pair of opposed side walls, the compartment area being integrally formed as a single unit;
(b) a lower compartment detachably connected to the upper compartment and having a pair of opposed side walls, a rear wall, a bottom wall and a portal front wall, cooperating with the front wall opening of the upper compartment to define an ingress and egress access into the interior of the shower;
(c) a plurality of legs secured to the bottom wall of the lower compartment; and
(d) a removable slotted door for closing off the cut-off portion and portal of the front walls of the upper and lower compartments.

2. The animal shower of claim 1 which further comprises a drain outlet, formed in the upper shower compartment bottom wall, in fluid communication with the interior of the shower area to enable drainage of any water collected therewithin.

3. The animal shower of claim 1 which further comprises at least a pair of portals formed on at least one side wall of the upper compartment for facilitating washing of an animal therethrough, each portal having a waterproof liner for the hands of a user which extends into the interior.

4. The shower of claim 1 which further includes a ramp detachably connected to the lower compartment front wall for facilitating ingress and egress by an animal into the interior of the shower.

5. The shower of claim 1 wherein the top wall of the upper compartment has a plurality of openings formed therein for circulating air into the interior of the shower.

6. The shower of claim 1 which further comprises:
a ground engaging pad removably attachable to an associated leg disposed at the bottom thereof.

7. The shower of claim 1 which further comprises:
a plurality of extension blocks removably attachable to the legs.

8. The shower of claim 8 which further comprises a ground engaging pad removably attachable to an associated block disposed at the bottom thereof.
